(19) United States
(12) Patent Application Publication
(10) Pub. No.: US 2013/0215074 A1
(43) Pub. Date: Aug. 22, 2013

(54) TOUCH DEVICE

(71) Applicant: Chih-Chung Lin, Taipei City (TW)

(72) Inventor: Chih-Chung Lin, Taipei City (TW)

(73) Assignee: Chih-Chung Lin, Taipei City (TW)

(21) Appl. No.: 13/442,876

(22) Filed: Apr. 10, 2012

(30) Foreign Application Priority Data
Feb. 17, 2012 (TW) 101105168

(51) Int. Cl. G06F 3/041

(52) U.S. Cl. 345/174

(57) ABSTRACT

A touch device includes a transparent capacitive substrate having a first side and an opposite second side, a transparent electromagnetic substrate having a third side and an opposite fourth side, and a bonding layer applied to between the second side of the transparent capacitive substrate and the third side of the transparent electromagnetic substrate, so that the transparent capacitive substrate and the transparent electromagnetic substrate are bonded together via the bonding layer. With the transparent capacitive substrate and the transparent electromagnetic substrate electrically integrated into the touch device, the touch device can provide more than one touch manner and is therefore more convenient for use.

This application claims the priority benefit of Taiwan patent application number 101105168 filed on Feb. 17, 2012.

### FIELD OF THE INVENTION

The present invention relates to a touch device, and more particularly to a touch device that provides more than one touch manner and is therefore more convenient for use.

### BACKGROUND OF THE INVENTION

Due to the quick development in the information technological and communication network fields, various kinds of electronic information products have become highly popular among consumers. Meanwhile, touch panels for electronic information products are also quickly developed. According to the sensing principles thereof, the currently available touch panels can be classified into four major types, namely, resistive, capacitive, electromagnetic, and optical touch panels. Among other, the capacitive touch panel is characterized by its good dust resistance, fire resistance and high definition, and is therefore widely welcomed among users. With the capacitive touch panel, the location of a touched point is determined from change in the capacitance of the touch panel. That is, the coordinates of the touched point on the touch panel is determined from the capacitance change between electrodes resulted from the approach of a conductive object, such as a finger, to the touch panel.

The capacitive touch panel has gradually become the mainstream in the touch technology and is applied to various electronic information products, such as cell phones, tablet computers, walkmans, hand-held electronic devices (apparatus), various displays, monitors, etc. According to the technological principle of these electronic information products using capacitive touch panel, the capacitance change on the touch panel caused by the minor current from human body touching the panel is sensed and further used to detect the change of position of the finger on the touch panel and the function selected through touch, so as to achieve the purpose of controlling the display.

According to the technological principle of electromagnetic touch panel, when the touch panel is touched by a pressure-sensitive electromagnetic stylus internally having a resonant circuit, a change in the magnetic field from a digital antenna occurs. At this point, the electromagnetic touch panel computes the position of the pressure-sensitive stylus, i.e. the location of touch, according to the change in the magnetic flux on the touch panel.

Therefore, the capacitive touch panel and the electromagnetic touch panel have their own touch manner, and these two touch manners are different and respectively have advantages and disadvantages. With the constant progress in various technological fields, consumers now demand more for the applicability and usability of the touch panel, and a touch panel providing only one touch manner gradually fails to satisfy the consumers' requirements.

### SUMMARY OF THE INVENTION

A primary object of the present invention is to provide a touch device that provides more than one touch manner and is therefore more convenient for use.

To achieve the above and other objects, the touch device according to a preferred embodiment of the present invention includes a transparent capacitive substrate having a first side and an opposite second side; a transparent electromagnetic substrate having a third side and an opposite fourth side, and being attached at the third side to the second side of the transparent capacitive substrate; and a bonding layer being applied to between the second side of the transparent capacitive substrate and the third side of the transparent electromagnetic substrate to bond the two substrates together. With the above arrangements, the touch device is more convenient for use because it provides diversified applications.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded sectional view of a touch device according to a first preferred embodiment of the present invention;

FIG. 2 is an assembled view of FIG. 1;

FIG. 3 is an exploded sectional view of a touch device according to a second preferred embodiment of the present invention; and

FIG. 4 is an exploded sectional view of a variant of the touch device according to the second preferred embodiment of the present invention.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

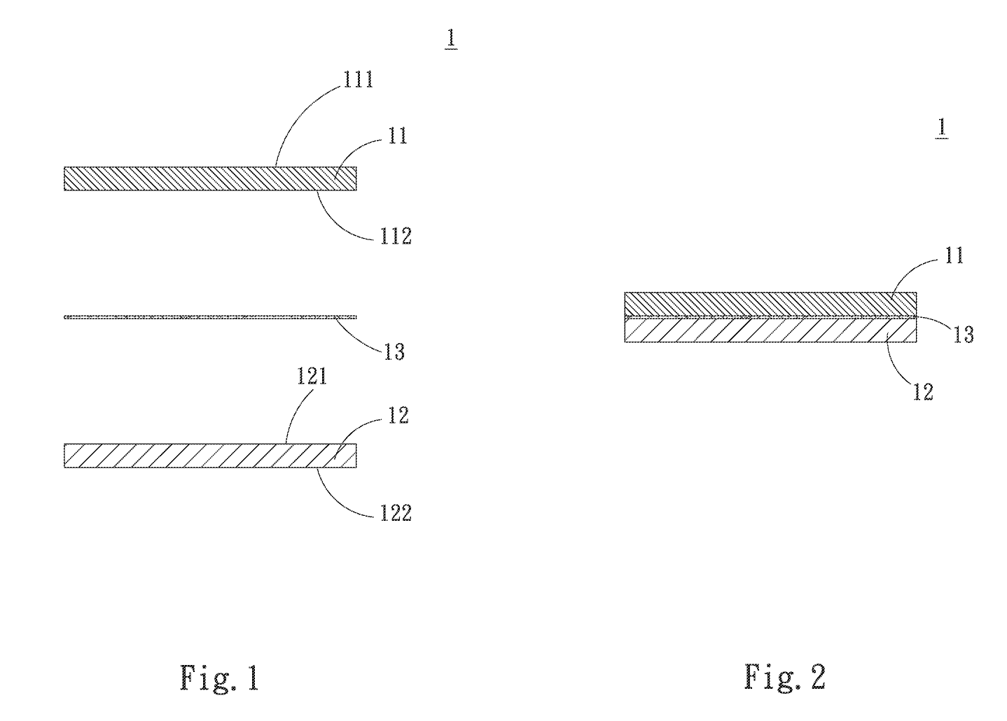

Please refer to FIGS. 1 and 2 that are exploded and assembled sectional views, respectively, of a touch device 1 according to a first preferred embodiment of the present invention. As shown, the touch device 1 includes a transparent capacitive substrate 11, a transparent electromagnetic substrate 12, and a bonding layer 13. In the illustrated first preferred embodiment, the transparent capacitive substrate 11 is made of a glass material without being limited thereto. That is, the transparent capacitive substrate 11 can also be made of other materials, such as polyethylene terephthalate (PET), polycarbonate (PC), polyethylene (PE), polyvinylchloride (PVC), polypropylene (PP), polystyrene (PS), polymethylmethacrylate (PMMA), or cyclo olefin copolymer (COC).

The transparent capacitive substrate 11 has a first side 111 and an opposite second side 112, so that the touch device 1 is able to sense any capacitance change thereof caused by a minor current from a human body touching the transparent capacitive substrate 11 and accordingly achieves the purpose of controlling the display on the touch device via touch.

In the illustrated first preferred embodiment, the transparent electromagnetic substrate 12 is made of a glass material without being limited thereto. That is, the transparent electromagnetic substrate 12 can also be made of other materials, such as PET, PC, PE, PVC, PP, PS, PMMA or COC.

The transparent electromagnetic substrate 12 has a third side 121 and an opposite fourth side 122, so that the touch device 1 is able to compute the position of a pressure-sensitive stylus touching the transparent electromagnetic substrate 12 according to the change in the magnetic flux on the touch device to thereby achieve the purpose of controlling the display on the touch device via touch.

The bonding layer 13 can be an optical clear adhesive (OCA) or an optical clear resin (OCR), and is applied to between the transparent capacitive substrate 11 and the transparent electromagnetic substrate 12. That is, the bonding layer 13 has one side glued to the second side 112 of the transparent capacitive substrate 11 and another opposite side glued to the third side 121 of the transparent electromagnetic substrate 12, so that the transparent capacitive substrate 11 and the transparent electromagnetic substrate 12 are bonded together to form an integral body via the bonding layer 13.

With the transparent capacitive substrate 11 and the transparent electromagnetic substrate 12 electrically integrated into the touch device 1, the touch device 1 according to the first preferred embodiment of the present invention is more convenient for use because it provides diversified applications.

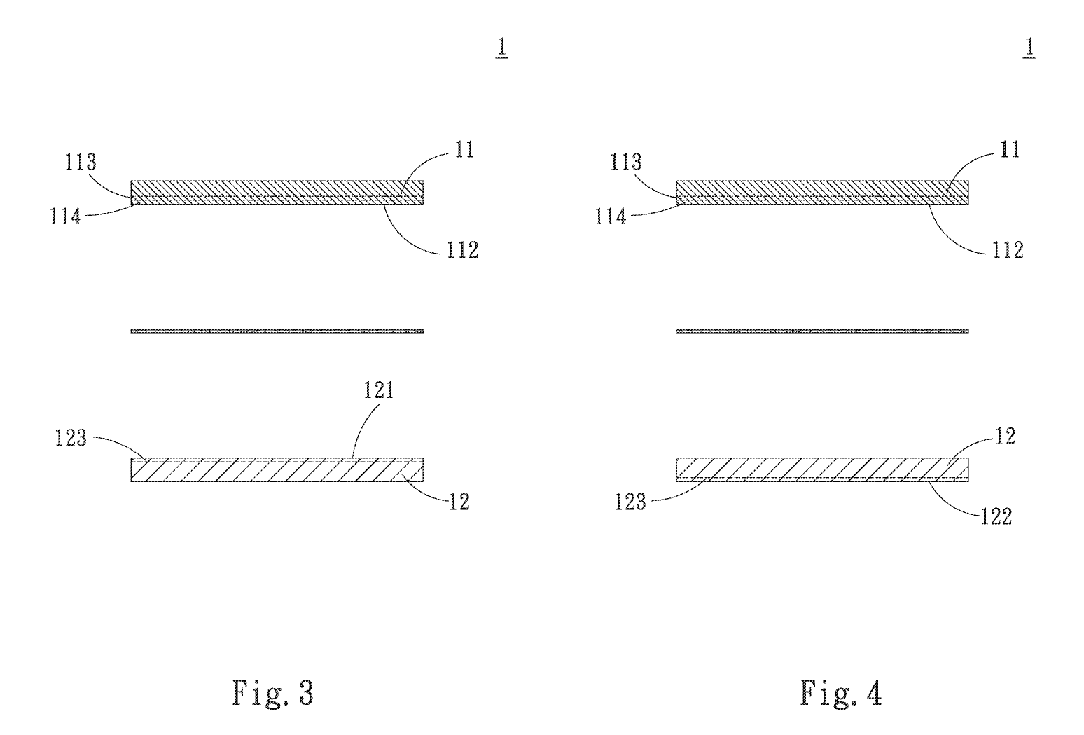

FIG. 3 is an exploded sectional view of a touch device 1 according to a second preferred embodiment of the present invention, and FIG. 4 shows a variant of the second preferred embodiment. As shown, the second preferred embodiment and the variant thereof are generally structurally similar to the first preferred embodiment, except that, in the second preferred embodiment, the transparent capacitive substrate 11 further has a first and a second conductive layer 113, 114 and the transparent electromagnetic substrate 12 further has an electromagnetic sensing layer 123.

The first conductive layer 113 and the second conductive layer 114 are formed on the second side 112 of the transparent capacitive substrate 11 to face each other, and may respectively be a thin film of indium tin oxide (ITO) or a thin film of antimony tin oxide (ATO). In the illustrated second preferred embodiment, the first and the second conductive layer 113, 114 are formed on the second side 112 by way of coating and etching without being limited thereto. In practical implementation of the present invention, it is also possible to form the first and the second conductive layer 113, 114 on the second side 112 by way of screen printing process or photolithography and etching process.

The electromagnetic sensing layer 123 is provided on the third side 121 or the fourth side 122 of the transparent electromagnetic substrate 12, as shown in FIG. 3 and FIG. 4, respectively. In the illustrated second preferred embodiment, the electromagnetic sensing layer 123 may be a color filter (CF), a thin film transistor (TFT) array, a backlight module, or any combination thereof. Further, the electromagnetic sensing layer 123 can be formed on the third side 121 or the fourth side 122 of the transparent electromagnetic substrate 12 by way of coating and etching without being limited thereto. In practical implementation of the present invention, it is also possible to form the electromagnetic sensing layer 123 on the third side 121 or the fourth side 122 of the transparent electromagnetic substrate 12 by way of screen printing process or photolithography and etching process. Therefore, with the transparent capacitive substrate 11 and the transparent electromagnetic substrate 12 electrically integrated into the touch device 1, the touch device 1 according to the second preferred embodiment of the present invention is more convenient for use because it provides diversified applications.

In brief, the present invention is superior to the prior art touch device because it provides at least one more touch manner and it is more convenient for use.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A touch device, comprising:
a transparent capacitive substrate having a first side and an opposite second side;
a transparent electromagnetic substrate having a third side and an opposite fourth side, and being attached at the third side to the second side of the transparent capacitive substrate; and
a bonding layer being applied to between the transparent capacitive substrate and the transparent electromagnetic substrate to bond the two substrates together.

2. The touch device as claimed in claim 1, wherein the bonding layer bonds the second side of the transparent capacitive substrate to the third side of the transparent electromagnetic substrate.

3. The touch device as claimed in claim 1, wherein the transparent capacitive substrate further has a first conductive layer and a second conductive layer.

4. The touch device as claimed in claim 3, wherein the first and the second conductive layer are formed on the second side of the transparent capacitive substrate to face each other.

5. The touch device as claimed in claim 1, wherein the transparent electromagnetic substrate further has an electromagnetic sensing layer.

6. The touch device as claimed in claim 1, wherein the transparent capacitive substrate and the transparent electromagnetic substrate are made of a material selected from the group consisting of glass, polyethylene terephthalate (PET), polycarbonate (PC), polyethylene (PE), polyvinylchloride (PVC), polypropylene (PP), polystyrene (PS), polymethylmethacrylate (PMMA), and cyclo olefin copolymer (COC).

7. The touch device as claimed in claim 3, wherein the first and the second conductive layer are formed of a material selected from the group consisting of a thin film of indium tin oxide (ITO) and a thin film of antimony tin oxide (ATO).

8. The touch device as claimed in claim 3, wherein the first and the second conductive layer are formed on the second side of the transparent capacitive substrate through coating and etching.

9. The touch device as claimed in claim 5, wherein the electromagnetic sensing layer is selected from the group consisting of a color filter (CF), a thin film transistor (TFT) array, a backlight module, and any combination thereof.

10. The touch device as claimed in claim 1, wherein the bonding layer is selected from the group consisting of optical clear adhesive (OCA) and optical clear resin (OCR).
